(19) United States
(12) Patent Application Publication
(10) Pub. No.: US 2026/0306946 A1
(43) Pub. Date: Oct. 8, 2026

(54) AI-DRIVEN VIDEO GAME SETTING SUGGESTIONS

(71) Applicant: SONY INTERACTIVE ENTERTAINMENT INC., Tokyo (JP)

(72) Inventors: Mingtao WU, San Francisco, CA (US); Edward CHEUNG, San Mateo, CA (US); Alex SONG, Palo Alto, CA (US); Daniel HIATT, San Francisco, CA (US); Mayu WATANABE, Los Angeles, CA (US); Chris THIELBAR, El Cerrito, CA (US)

(21) Appl. No.: 19/169,651

(22) Filed: Apr. 3, 2025

(51) Int. Cl. A63F 13/533; A63F 13/79; G06F 40/20

(52) U.S. Cl. CPC A63F 13/533; A63F 13/79; G06F 40/20; A63F 2300/308

(57) ABSTRACT

Techniques described herein include receiving a request for a setting suggestion, the request associated with a desired gaming experience or action and generating, based on the request, input data for a machine learning model trained to predict setting suggestions. The techniques also include using the input data to obtain one or more setting suggestion results from the machine learning model corresponding to one or more settings which can cause the gaming console or the video game to operate according to the desired gaming experience or desired action. The one or more setting suggestion results can include instructions for implementing the one or more settings. The techniques further include generating a graphical user interface page that includes the one or more setting suggestion results and transmitting the graphical user interface page to a display communicatively coupled to the gaming system.

### BACKGROUND

Gaming systems and entertainment environments offer users a wide range of customizable settings, including graphics, audio, gameplay preferences, and accessibility options. However, as the number of available settings continues to grow, users often face challenges in efficiently navigating, configuring, and managing these options to optimize their experience. This creates a need for improved systems and methods that enable intuitive and streamlined management of large volumes of setting options.

### SUMMARY

Techniques disclosed herein pertain to gaming systems. Particularly, techniques disclosed herein pertain to improving gaming systems using artificial-intelligence-driven (AI-driven) video game setting suggestions.

In some embodiments, a method includes: receiving, by one or more processors of a gaming system, a request for a setting suggestion, the request being associated with a desired gaming experience or desired action; generating, by the one or more processors and based on the request, input data for a machine learning model trained to predict setting suggestions; using, by the one or more processors, the input data to obtain one or more setting suggestion results from the machine learning model, the one or more setting suggestion results corresponding to one or more settings which when applied to a gaming console or video game cause the gaming console or the video game to operate according to the desired gaming experience or desired action, wherein the one or more setting suggestion results comprise instructions for implementing the one or more settings; generating, by the one or more processors, a graphical user interface page comprising the one or more setting suggestion results; and transmitting, by the one or more processors, the graphical user interface page to a display communicatively coupled to the gaming system.

In some embodiments, the machine learning model is configured to return the one or more setting suggestion results based at least in part on historical data of a group of users for a particular gaming experience or action provided to the machine learning model.

In some embodiments, the machine learning model is configured to return the one or more setting suggestion results based at least in part on comparing user data of a user associated with the request to the historical data of a group of users for a particular gaming experience or action.

In some embodiments, the method further includes implementing, by the one or more processors, the one or more setting suggestion results on the game console or video game.

In some embodiments, the method further includes: receiving, by the one or more processors, a natural language request input by the user; inputting, by the one or more processors, the natural language request to a second machine learning model trained to determine the desired gaming experience or desired action based at least in part on the natural language request; and generating, by the one or more processors using the second machine learning model, the request for a setting suggestion.

In some embodiments, the machine learning model is trained to predict one or more setting suggestions to achieve a particular gaming experience or action based on historical data of a group of users for a particular gaming experience or action, and the machine learning model is trained to predict the particular gaming experience or action of the historical data of the group of users based at least in part on determining patterns in the historical data of the group of users corresponding to associated gaming experiences or actions.

In some embodiments, the machine learning model is trained to predict setting suggestions to achieve the particular gaming experience or action based on historical data of a user associated with the request and the historical data the group of users, and the machine learning model is trained to predict the particular gaming experience or action based at least in part on determining patterns in the historical data of the user and the historical data of the group of users corresponding to the associated gaming experiences or actions.

Some embodiments include a gaming system that includes one or more processors and one or more computer-readable media storing instructions which, when executed by the one or more processors, cause the gaming system to perform part or all of the operations and/or methods disclosed herein.

Some embodiments include one or more non-transitory computer-readable media storing computer-readable instructions that, when executed by one or more processors, cause the processors to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Features, embodiments, and advantages of the present disclosure are better understood when the following Detailed Description is read with reference to the accompanying drawings.

FIG. 1 illustrates a computer system that presents a dashboard, according to some embodiments of the present disclosure.

FIG. 2 illustrates an example of a setting suggestion system, according to some embodiments of the present disclosure.

FIG. 3 illustrates an example presentation of a setting suggestion, according to some embodiments of the present disclosure.

FIG. 4 illustrates an example presentation of a setting suggestion, according to some embodiments of the present disclosure.

FIG. 5 illustrates an example presentation of a setting suggestion, according to some embodiments of the present disclosure.

FIG. 6 illustrates an example presentation of a setting suggestion, according to some embodiments of the present disclosure.

FIG. 7 illustrates an example process for AI-driven video game suggestions, according to some embodiments of the present disclosure.

FIG. 8 illustrates an example of a hardware system suitable for implementing a computer system, according to some embodiments of the present disclosure.

In the appended figures, similar components and/or features may have the same reference label. Further, various components of the same type may be distinguished by following the reference label with a dash and a second label that distinguishes among the similar components. If only the first reference label is used in the specification, the description is applicable to any one of the similar components having the same first reference label, irrespective of the second reference label.

### DETAILED DESCRIPTION

In the following description, for the purposes of explanation, specific details are set forth to provide a thorough understanding of certain embodiments. However, it will be apparent that various embodiments may be practiced without these specific details. The figures and description are not intended to be restrictive. Furthermore, well-known features may be omitted or simplified in order not to obscure the embodiment being described.

Techniques described herein improve gaming systems by enabling gaming systems to analyze user setting behavior corresponding to particular gaming experiences and/or desired actions, generating setting suggestions, and providing instructions for implementing the setting suggestions, to tailor their gaming experience to user needs, expectations, and desires. The described embodiments can significantly improve gaming systems by leveraging machine learning to optimize and automate the configuration of settings, reducing computational inefficiencies, and enhancing system performance. In some examples, a user can request setting suggestions for a particular type of gaming mode via a user interface (e.g., a game console). The system can provide users with personalized recommendations for adjusting one or more settings to enhance their gaming or entertainment experience based on their preferences, usage patterns, or system performance data. Additionally, the system can verify whether specific settings are already configured to the suggested values, offering users the option to confirm or modify these settings as needed. This facilitates an optimized configuration process, reducing user effort while maximizing functionality and satisfaction. The setting suggestions can be generated by one or more machine learning models trained to predict setting suggestions for particular gaming experiences or actions. The one or more machine learning models can be trained using historical data of a group of users and/or data pertaining to a user console and/or user account data associated with the user console.

By analyzing historical setting usage data and identifying patterns across a large group of users, the described embodiments can enable a gaming system to predict and apply optimal configurations tailored to specific gaming experiences or actions. This can reduce the need for users to manually adjust settings, minimizing trial- and error processes that can lead to suboptimal resource allocation, such as unnecessarily high graphics settings causing frame drops or performance bottlenecks. Additionally, the described embodiments can dynamically adjust settings in real time or preemptively recommend configurations based on contextual data, such as game type or level conditions, ensuring that resources like GPU, CPU, and memory are utilized efficiently. This not only enhances the overall stability and responsiveness of the gaming system but also reduces wear on hardware components by avoiding excessive strain from misconfigured settings.

Gaming consoles can be equipped with an extensive array of settings designed to cater to diverse user preferences and enhance the overall gaming experience. These settings can range from core gameplay adjustments to peripheral configurations, such as sound controls, lighting effects, avatar customization, and network setups. For instance, users may want to fine-tune audio settings to balance dialogue and background music, adjust lighting parameters to minimize eye strain during extended play, or personalize their avatars with detailed facial features and clothing options. Additionally, consoles often include device management settings for controllers, headsets, and external storage, further adding to the complexity of available options. While this level of customization empowers users to create highly personalized experiences, it also introduces significant challenges in navigating and managing the sheer volume of settings.

For many users, finding the right settings for their specific needs can be a daunting task. Settings are often scattered across multiple menus and submenus, each labeled with technical terms or ambiguous descriptions that may not be immediately clear to the average user. Additionally, a gaming system may not offer the optimal combination of settings for a desired result. For example, a gamer seeking to optimize graphics performance for a smoother gameplay experience may need to adjust settings, such as resolution, frame rate, and HDR configurations—each located in separate sections of the console's interface. Similarly, accessibility features, such as text-to-speech or colorblind mode, may not be available on the system, leaving users frustrated as they search for solutions to improve their experience. This lack of centralized or streamlined navigation can lead to confusion, misconfiguration, and, ultimately, lead to inefficient GPU, CPU, and memory usage. To address these challenges, there is a growing need for systems and methods that simplify the process of locating, understanding, and configuring settings on gaming consoles. The techniques described herein can provide intuitive guidance, such as personalized recommendations, based on usage patterns or real-time prompts for optimizing system performance. Additionally, features that consolidate related settings into cohesive categories or offer search functionality could significantly reduce the effort required to find specific options. By streamlining the process of managing settings, the techniques described herein can improve the overall stability and performance of the gaming system, while also preserving hardware longevity by preventing unnecessary strain caused by improper configuration of settings.

A request for a setting suggestion for a desired gaming experience or desired action can require a multi-dimensional response. Gaming experiences can be highly diverse, with players often seeking to tailor settings to match specific modes, actions, or preferences for an immersive experience. For example, a player diving into a fast-paced first-person shooter may prioritize frame rate and responsiveness, requiring adjustments to graphics quality, motion blur, and controller sensitivity. On the other hand, a user playing a cinematic role-playing game may focus on enhancing visual fidelity and sound quality to fully immerse themselves in the story, adjusting settings like HDR, surround sound, and subtitles. Even casual gaming scenarios, such as engaging in a multiplayer session with friends, may require configuring voice chat volume, microphone sensitivity, and network prioritization to ensure smooth communication and connectivity. These diverse needs highlight the importance of dynamic, context-aware setting adjustments to optimize the experience for specific gaming modes or actions. By leveraging factors, such as the user's gameplay preferences, historical usage data, and system performance metrics, the described system can intelligently recommend configurations that enhance the user's experience. For instance, when a player initiates a competitive gaming mode, the system could suggest settings that prioritize low latency and high responsiveness, while a storytelling mode could prompt recommendations for enhanced visuals and audio. By utilizing machine learning models trained on historical and aggregated data, the system eliminates the need for users to manually adjust intricate settings, many of which require a deep understanding of hardware capabilities, software compatibility, and performance optimization. This not only saves users time and effort but also reduces the likelihood of errors or inefficiencies in configuration, enabling the system to operate at peak performance.

Additionally, the setting suggestion can be informed by the preferences and presumed preferences of a user. Users often have distinct preferences that reflect their individual playstyles, favorite genres, and technical priorities. These preferences can include a liking for certain types of games, such as action-adventure, sports, or simulation, as well as specific settings, such as high graphics quality, immersive audio, or accessibility features, like larger text or colorblind modes. Additionally, users may have preferences related to controller sensitivity, online multiplayer matchmaking, or even in-game customization options, like avatar design. However, many of these preferences are not explicitly defined by the user but can be inferred from their gaming behavior, such as the types of games they frequently play, the settings they adjust most often, or the way they interact with the system over time.

Gaming console data provides a powerful tool for identifying these preferences and presumed preferences, both on an individual and group level. For example, a console can track the games a user plays most frequently, the duration of their gaming sessions, and the settings they modify within those games. If a user consistently plays competitive first-person shooters, the system might infer a preference for settings that prioritize low latency and high frame rates. Similarly, if a group of users within a household plays games with cooperative modes, the console could identify common preferences, such as voice chat configurations or shared display settings. Additionally, aggregated data across a larger user base can help identify trends and recommend settings based on what works well for similar users or games.

By leveraging this data, the techniques described herein can deliver personalized and context-aware setting suggestions that align with a user's preferences or presumed preferences. For instance, if a player regularly adjusts audio settings for enhanced bass and dialogue clarity in story-driven games, the system could preemptively recommend similar configurations when the user launches a new title in that genre. Similarly, if a user frequently enables accessibility features, such as subtitles or controller remapping, the system could suggest enabling these settings by default for compatible games. Further, by intelligently identifying and suggesting the optimal combination of settings, the system can help users achieve their gaming objectives effortlessly. These intelligent recommendations not only enhance the user's experience and reduce the burden of manually configuring settings but also introduce a broader variety of features and combinations that the user may not be aware of or realize work synergistically. The embodiments described herein can minimize resource misallocation, prevent performance bottlenecks, and dynamically adapt to changing conditions, such as different game levels, ensuring that the gaming system delivers an optimal experience without requiring the users to have technical expertise.

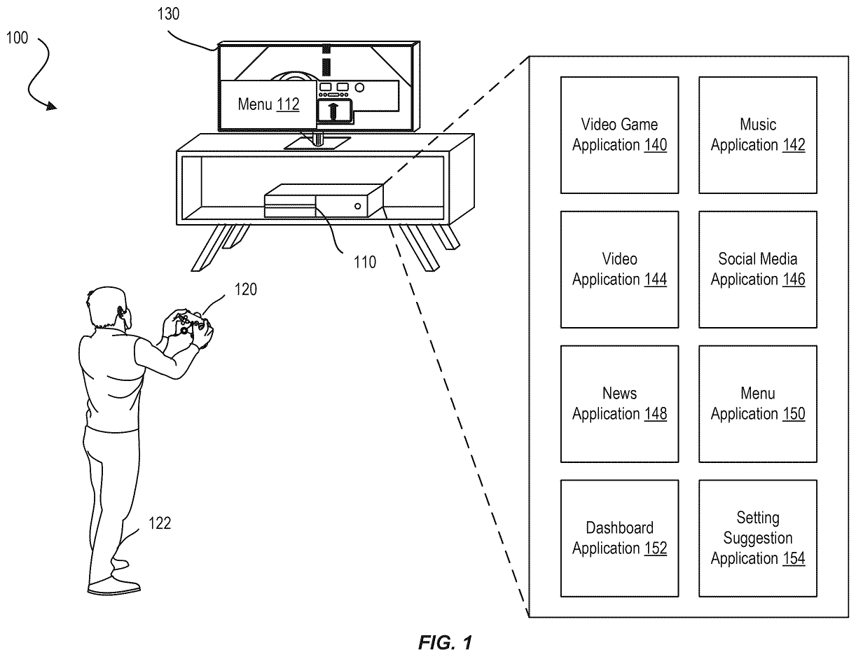

FIG. 1 illustrates a computer system 100 that presents a dashboard, according to some embodiments of the present disclosure. As illustrated, the computer system includes a video game console 110, a video game controller 120, and a display 130. Although not shown, the computer system may also include a backend system, such as a set of cloud servers, that is communicatively coupled with the video game console 110. The video game console 110 is communicatively coupled with the video game controller 120 (e.g., over a wireless network) and with the display 130 (e.g., over a communications bus). A user 122 operates the video game controller 120 to interact with the video game console 110. These interactions may include playing a video game presented on the display 130, interacting with a menu 112 presented on the display 130, and interacting with other applications of the video game console 110 (e.g., with media applications to stream media from an online content source or to play a media file from the local storage of the video game console 110).

The video game console 110 includes a processor and memory (e.g., a non-transitory computer-readable storage medium), storing computer-readable instructions that can be executed by the processor and that, upon execution by the processor, cause the video game console 110 to perform operations related to various applications. In particular, the computer-readable instructions can correspond to program codes for the various applications of the video game console 110, including video game application 140, music application 142, video application 144, social media application 146, and news application 148. A video game application, such as the video game application 140, generally represents a computer application executable to present video game content, receive user interaction with the video game content, and accordingly update the video game content. A media application, such as the music application 142, video application 144, social media application 146, or news application 148, generally represents a computer application executable to present media content (i.e., audio, video, and/or other media types), receive user interaction with the media content, and accordingly update the media content. The media content can be streamed from a remote content source or can be presented from local storage of the video game console 110. Further, other applications can be likewise included in the video game console 110, such as a chat application. The availability of a video game application, media application, and/or other type of computer application to the user 122 via the video game console 110 can depend on a user identifier of the user 122 (e.g., upon a login to the video game console 110, the availability of the computer applications can depend on the user identifier used in the login).

In addition, the video game console 110 includes a menu application 150, a dashboard application 152, and a setting suggestion application 154. The menu application 150 can present user interfaces (UIs) in a GUI of the display 130. One or more UIs of the UIs presented by the menu application 150 can facilitate logging into the video game console 110, guiding a login process for logging into the video game console 110, presenting information associated with logging into the video game console 110, and the like. For example, one UI of the UIs presented by the menu application 150 can present fields for entering account credentials (e.g., a user identifier and a password). In another example, another UI of the UIs presented by the menu application 150 can present information for creating a user profile account. In yet another example, a subset of UIs of the UIs presented by the menu application 150 can facilitate and/or guide an end user through a login process for logging into the video game console 110 and/or a user account associated with an entity providing the video game console 110. The dashboard application 152 can present an arrangement of interactive UI widgets in a dashboard page on the GUI. The setting suggestion application 154 may implement a gaming system or portions of a gaming system for generating setting suggestions. The gaming system can leverage machine learning models, to analyze user data, game-specific parameters, system-specific parameters, and aggregated data to provide the setting suggestions. Additionally, the system can store the generated recommendations for future reference, allowing users to revisit and reapply preferred configurations without re-entering their preferences. To enhance accessibility and integration, the gaming system may also transmit the recommendations to other devices or components, such as cloud services, gaming consoles, or companion apps, ensuring consistency across platforms. By centralizing the generation, storage, and transmission of setting suggestions, the gaming system not only streamlines the user experience but also enables adaptive optimization based on real-time inputs and historical trends.

The video game controller 120 is an example of an input device. The video game controller 120 may allow the user 122 to interact with one or more GUIs presented by the video game console 110 on the display 130. For example, using one or more directional control inputs (e.g., a joystick and/or a directional pad), the user can navigate to and within various menus, dashboards, and UI elements. Other types of input device are possible, including a keyboard, a touchscreen, a touchpad, a mouse, an optical system, a microphone, a camera, or other user devices suitable for receiving input of a user. For example, a microphone may allow the user 122 to interact with the GUIs by using various voice commands. As another example, a camera may allow the user 122 to interact with the GUIs by using various gesture commands.

Upon an execution of the video game application 140 by the video game console 110, a rendering process of the video game console 110 presents video game content (e.g., illustrated as a car race video game) on the display 130. Upon user input from the video game controller 120 (e.g., a user push of a particular key or button), the rendering process also presents the menu 112. Additionally, or alternatively, the menu 112 may be presented as an initial landing page, in response to a user powering-on the video game console 110 and/or waking the video game console 110 from a suspended state. Depending on the user input, the menu 112 corresponds to the home UI page, a landing page, or the like. The menu 112 can be presented in a layer over the video game content.

Upon the presentation of the menu 112, the user control changes from the video game application 140 to the menu application 150. Upon receiving a user input from the video game controller 120 requesting interactions with the menu 112, an underlying application (e.g., the menu application 150, the dashboard application 152, etc.) supports such interactions by updating the menu 112 and launching any relevant application in the background or foreground. The user 122 can exit the menu 112 or automatically dismiss the menu 112, upon the launching of an application in the background or foreground. Upon exiting the menu 112 or the dismissal based on a background application launch, the user control changes from the underlying application to the video game application 140.

As described in more detail below, the dashboard application 152, when executed, may generate a dashboard (e.g., a “widget menu,” “landing page,” and/or “explore page”) configured to present information from applications and services available to the video game console 110 as interactive UI widgets. The term “widget” is used herein as an example of an interactive UI element generated and/or presented by the dashboard application 152 and corresponding to an application or service of the computer system. Other implementations to present a UI element are possible, including any type of icon, whether a widget, a tile, a thumbnail, a text description, a multiple-column element with textual or graphical description in each column, or the like. As described further below, widgets may be presented with application information and/or dynamic content presented with the widget in a media library. For example, the dashboard application 152 may generate and/or present widgets associated with media applications, system applications and/or services, video game applications, or the like.

As described in detail below, the dashboard application 152 may be executed via multiple avenues of ingress. For example, the dashboard application 152 may be executed by a pre-defined user interaction (e.g., via controller 120, a voice command from the user 122, activating and/or powering-on the video game console 110 etc.) and/or by navigating one or more menus and/or sub-menus of the video game console 110 (e.g., menu 112).

The video game console 110 may generate game console data. The game console data may include data generated by one or more applications running on the video game console 110. For example, the video game application 140 may generate video game application data. The video game application data may include data representing levels completed, achievements unlocked, and missions accomplished, within the video game, time of day when the video game application is used, session duration, and total time spent playing the video game, how often the user 122 plays the video game, choices made during gameplay (e.g., character selection, weapon preferences, or strategies), preferred difficulty level (e.g., easy, medium, hard), location data, game genre, engagement with multiplayer features, chat data, user group data (e.g., who the user 122 plays with), what people have taken screenshots of, an artistic style, and/or a mechanic, etc.

In another example, the news application 148 may generate news data. The news data may include data representing specific articles or topics the user 122 reads (e.g., an article about an upcoming video game or video game feature), how much time the user 122 spends reading a particular article or topic, how often the user opens the app or reads articles, how the user 122 navigates through the app (e.g., scrolling speed, clicks on headlines, links, or ads), keywords or topics the user searches for within the application, content the user chooses to save for later or mark as important, articles or topics the user shares via the social media application 146, use of specific app features, such as notifications, comment sections, or personalization tools, news sources, and/or authors (e.g., a game developer), etc.

In another example, the music application 142 may generate music data. The music data may include data representing frequency of music application usage, time of day when the application is used, and session duration, songs or playlists that are played, skipped, paused, or replayed, songs, albums, artists, or playlists that the user marks as “liked,” “favorited,” or adds to their library, terms or keywords used by the user in the application's search feature, personalized playlists created by the user, which may indicate preferences for specific genres, moods, or themes, songs, playlists, or albums shared with others via the social media application 146, genres the user listens to most often (e.g., rock, jazz, pop, classical), specific artists or albums that are repeatedly played or followed, selection of mood- or activity-based playlists (e.g., “workout,” “relaxation,” “study”), and/or songs or genres associated with specific regions or cultures.

In another example, the video application 144 may generate video data. The video data may include data representing videos (e.g., videos related to certain video games, streams related to certain video games) or shows watched, including completion rates (e.g., fully watched, partially watched, or abandoned), search terms or keywords entered into the video application's search bar, indicating specific interests or queries, actions, (e.g., liking, disliking, commenting, sharing, or saving videos to playlists or watchlists), information about when videos are paused, rewound, fast-forwarded, or skipped, time spent watching videos, session lengths, binge-watching patterns, engagement with suggested videos or curated playlists, types of content frequently viewed (e.g., comedy, drama, sci-fi, documentaries, tutorials), specific creators, influencers, or channels the user 122 follows or frequently watches, interest in specific topics (e.g., cooking, fitness, gaming, technology, travel), languages of the videos watched, reflecting linguistic preferences or fluency, and preference for certain formats (e.g., short-form videos, live streams, or full-length movies), and/or online vs. offline viewing habits, etc.

In another example, the dashboard application 152 may generate dashboard data. The dashboard data may include data representing application usage patterns, customization choices (e.g., user selected widgets, backgrounds related to a certain video game, layouts, themes, etc.), responses to application notifications, and/or games on a wish list, etc.

In another example, the social media application 146 may generate social media data. The social media data may include data representing posts liked, shared, commented on, saved, or bookmarked, time spent viewing specific posts, videos, or stories (e.g., scrolling past vs. lingering on content), keywords, hashtags, profiles, or topics searched within the social media application 146, frequency, timing, and type of content shared by the user (e.g., text, images, videos, links), views, reactions, and replies, responses to interactive features like polls, quizzes, or surveys within the social media application 146, topics of interests, and/or followed accounts, etc.

Although FIG. 1 illustrates that the different applications are executed on the video game console 110, the embodiments of the present disclosure are not limited as such. Instead, the applications can be executed on the backend system (e.g., the cloud servers) and/or their execution can be distributed between the video game console 110 and the backend system.

In the interest of clarity of explanation, the embodiments may be described in connection with a video game system, including a video game console. However, the embodiments are not limited as such and similarly apply to any other type of a computer system. Generally, a computer system presents a dashboard in a GUI on a display. The dashboard presents UI elements, each corresponding to an application, service, or collection of information.

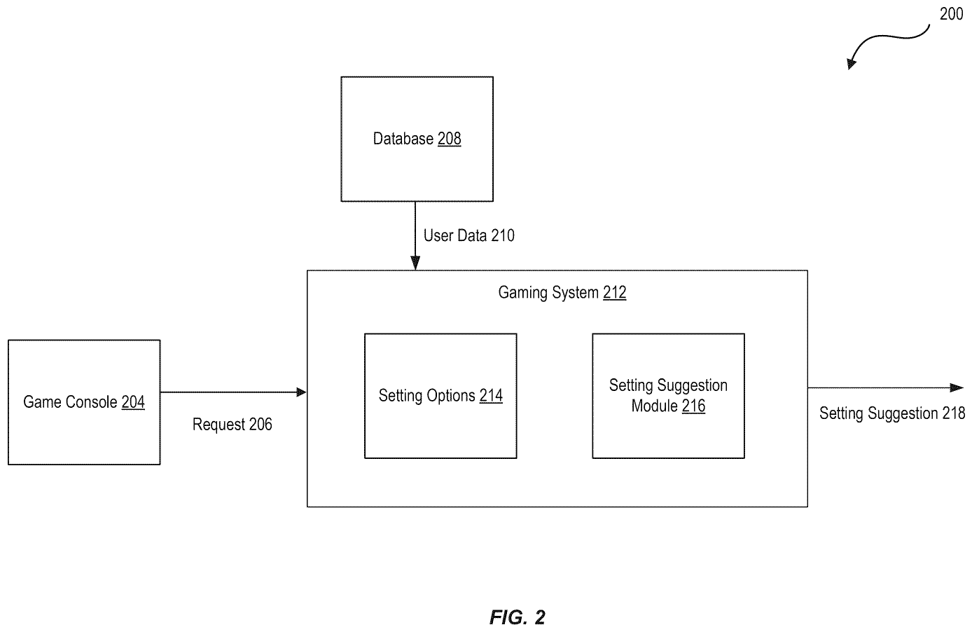

FIG. 2 illustrates an example of a setting suggestion system 200, according to some embodiments of the present disclosure. The setting suggestion system 200 can include game consol 204, database 208, gaming system 212, setting options 214, and setting suggestion module 216. The gaming system 212 can receive request 206 from the game console 204. The request can be for a setting suggestion to achieve a desired gaming experience or desired action. The gaming system 212 can also receive user data 210 from the database 208. The gaming system 212 can output setting suggestion 218.

### I. Data Collection

The gaming system 212 can receive various data from various sources such as the game console 204 and the database 208. The gaming system 212 can also receive the request 206 from the game console 204. The gaming system 212 can receive the game console data along with or separate from the request 206.

The game console data may be received from a game console associated with a user account of the user, applications executing on the game console and associated with the user account (e.g., video game applications, news applications, music applications, social media applications, etc.), and/or applications executing remotely from the game console and associated with the user account (e.g., video game applications, news applications, etc.). The game console data may be associated with a user account used with a game console. The game console data may include explicit and/or implicit indications of interests associated with the user account. For example, an explicit indication of an interest may include an answer to a question where user input was received indicating that a user of the user account likes adventure games, likes realistic-looking games, likes sandbox games, likes co-op games, likes player-versus-player games, etc. An implicit indication may be an interest indication determined from an analysis of game console data that does not explicitly indicate the interest. For example, game console data representing that the user account owns a lot of racing games can implicitly indicate that the user likes racing games. As another example, game console data representing that the user account has recently played 30 hours of a single sports game may indicate that a user has an interest in sports games (e.g., possibly even if the user account also owns a lot of sandbox games but has not recently played them).

The request 206 can be a natural language string input by a user at an interface (e.g., display) of the game console 204. In an example, a user might type or speak a sentence, such as “Optimize my settings for competitive play,” which can then be interpreted by one or more machine learning models, such as a large language model, trained to determine the appropriate configurations. Alternatively, the request 206 can be triggered by context-based actions, such as restarting the console, launching a specific game, or opening a newly-installed title, to proactively suggest relevant settings. The request 206 can be narrowly tailored to a particular action desired to be achieved or broadly requesting a gaming experience. For example, a user might request, “Configure my headset,” prompting the system to adjust or suggest adjusting microphone sensitivity, sound balance, and chat audio levels for optimal performance. Other requests could include, “Set my graphics for performance mode,” which prioritizes frame rates over visual fidelity, or “Enable accessibility features,” which activates options like text-to-speech, larger fonts, or colorblind mode. The request 206 can also include more general, experience-based queries, such as “Optimize my settings for playing with friends,” which could lead the gaming system 212 to suggest configuring voice chat, multiplayer connectivity, and controller preferences, accordingly.

The gaming system 212 can also receive the user data 210 from the database 208. The database 208 can store the user data 210 that is aggregated across a wide range of users to identify common trends and preferences for optimal setting recommendations. This could include data, such as the most frequently used settings for specific games, game genres, or even particular levels or missions within those games. For example, if most users in a first-person shooter lower motion blur and increase controller sensitivity for competitive matches, this trend can inform default recommendations for new users engaging in similar scenarios. Additionally, the database 208 could store information about the most commonly enabled accessibility features, such as subtitles or high-contrast visuals, to ensure the gaming system 212 proactively suggests these options to users who may benefit from them.

The database 208 can also store user data 210 that is specific to a particular user to generate personalized setting suggestions tailored to individual preferences and behaviors. This data might include the user's gaming history, such as the types of games they play most frequently, the settings they have adjusted in the past, and their typical play session durations. For instance, if a user consistently increases the brightness and adjusts the audio balance to emphasize dialogue in story-driven games, the gaming system 212 can suggest similar configurations when they start a new game in the same genre. The database 208 can also track hardware usage, such as whether the user connects a headset or external display, to recommend settings like surround sound or resolution adjustments.

In addition to general and specific user data, the user data 210 stored in the database 208 can include contextual and performance-related information to enable dynamic and scenario-specific setting suggestions. This might include data on the user's hardware capabilities, such as the console's performance metrics, connected peripherals, and network speed. For example, if a user's console is connected to a 4K television, the gaming system 212 might prioritize high-resolution graphics settings, whereas a slower internet connection could prompt recommendations for reducing latency in online multiplayer games. The database 208 can also track in-game contexts, such as the specific levels, modes, or actions that users are engaging in, to recommend adjustments accordingly. For instance, if users typically reduce ambient sound and increase footstep audio during stealth missions in a particular game, the gaming system 212 could suggest these changes automatically when the user reaches similar levels. By combining contextual and performance data with general and specific user preferences, the gaming system 212 can enable a comprehensive, data-driven approach to optimizing settings for all users.

The gaming system 212 can include the setting options 214 that are stored in a database of the gaming system 212 or received from different sources, such as the game console 204 and/or the database 208. The setting options 214 can include settings provided by the gaming system to allow users to customize their experience across numerous categories, often spread out over multiple menus and submenus. These setting options 214 can include graphics settings, such as resolution, frame rate, and HDR; audio settings, like volume balance, surround sound, and microphone sensitivity; gameplay settings, such as difficulty level, controller sensitivity, and motion blur; and accessibility options, like subtitles, colorblind modes, and text-to-speech functionality. Additionally, there may be device-specific setting options 214 for peripherals, such as headsets, controllers, and external displays, which can present challenges, such as ensuring compatibility, avoiding resource misallocation, and maintaining efficiency in configuration. The gaming system 212 can address this complexity by implementing a hybrid approach to setting management. The gaming system 212 can accomplish this by either storing all available setting options locally in its database for faster access or retrieving them dynamically from external sources, such as game developer servers or cloud-based repositories, to ensure the most up-to-date configurations are available. This dual approach minimizes the risk of outdated or missing options, while balancing storage limitations and processing overhead. Using this comprehensive pool of settings, the gaming system 212 can intelligently analyze the request 206, along with user data 210 stored in the database 208, to predict and suggest a tailored set of configurations. By dynamically adapting to the capabilities of connected peripherals and the specific preferences or needs of the user, the gaming system can overcome the inherent challenges of managing a diverse and large number of evolving, device-specific options.

To determine the setting suggestion 218 in response to the request 206, the gaming system 212 can generate, based on the request 206, input data for a machine learning model trained to predict the setting suggestion 218. The input data can include the request 206, along with some or all of the available data, and may be input to the setting suggestion module 216.

### II. Setting Suggestion Determination

The setting suggestion module 216 can use the input data to obtain the one or more setting suggestions 218 from a machine learning model. As discussed above, the gaming system 212 can input the request 206, along with some or all of the relevant and/or available data, to the setting suggestion module 216. The one or more setting suggestions 218 can correspond to one or more settings, which, when applied to a gaming console or video game, cause the gaming console or the video game to operate according to a desired gaming experience or desired action. The one or more setting suggestions 218 can include instructions for implementing the one or more settings.

According to some embodiments, a machine learning model of the setting suggestion module 216 can be configured to return one or more setting suggestion results based, at least in part, on historical data of a group of users for a particular gaming experience or action provided to the machine learning model. In some examples, the request 206 is not associated with a particular user (e.g., a user is using a console as a guest), and the setting suggestion 218 can be based on historical behavior of a group of users.

According to some embodiments, the machine learning model can be configured to return the one or more setting suggestion results based, at least in part, on comparing user data of a user associated with the request to the historical data of a group of users for a particular gaming experience or action. In some examples, the request 206 is associated with a particular user (e.g., a user account), and the setting suggestion 218 can be based on considering both the historical behavior of the particular user and the historical behavior of a group of users.

According to some embodiments, the machine learning models can be trained to predict one or more setting suggestions, to achieve a particular gaming experience or action based on historical data of a group of users for a particular gaming experience or action; and the machine learning models can be trained to predict the particular gaming experience or action of the historical data of the group of users based, at least in part, on determining patterns in the historical data of the group of users corresponding to associated gaming experiences or actions.

According to some embodiments, the machine learning model can be trained to predict setting suggestions, to achieve the particular gaming experience or action based on historical data of a user associated with the request and the historical data the group of users; and the machine learning model can be trained to predict the particular gaming experience or action based, at least in part, on determining patterns in the historical data of the user and the historical data of the group of users corresponding to the associated gaming experiences or actions.

The setting suggestion module 216 can include one or more machine learning models that are trained to generate the setting suggestion 218, in response to the request 206, based all or a portion of the user data 210, the game console data, and/or the setting options 214. The setting suggestion module 216 can be one or more machine learning models trained to analyze patterns in behavior and preferences. For example, a machine learning model of the setting suggestion module 216 can be trained to compare user-specific data (e.g., game console data) to general data (e.g., user data 210) about a group of similar users (e.g., users playing a similar or same game, users that are geographically located in a particular region, friends of the user), to identify shared preferences for settings of different games, genres, and content. The one or more machine learning models can be trained to analyze the attributes of items (e.g., settings, game features, themes, or mechanics) that a user has engaged with, to recommend similar settings. The one or more machine learning models can be a model that can process text-based inputs, such as user reviews, chat logs, or search queries, to infer interests from sentiment and keyword analysis. The one or more machine learning models can be a deep learning model that can identify complex patterns in user behavior by processing large datasets, such as clickstream data, playtime statistics, in-game actions, and setting histories. The one or more machine learning models can be a reinforcement learning model that can adapt to a user's changing interests by learning from real-time interactions, such as clickstream data and setting selection. Additionally, the one or more machine learning models can be clustering models that can group users into segments based on shared characteristics or behaviors. Further, the one or more models can be console-specific, based on the needs and performance abilities for particular hardware and compatibilities.

In some examples, the setting suggestion module 216 can generate setting suggestions 218 based on user preferences, historical data, and environmental factors. A machine learning model of the setting suggestion module 216 can analyze patterns in user behavior, such as preferred genres, themes, or prior settings selected, to generate personalized suggestions for a user. In some examples, input data to the machine learning model can be demographic information, geographic location, or cultural context, to craft settings that align with regional or group preferences. Additionally, contextual data, such as time of day, season, or even real-time events, could dynamically influence the model to suggest settings that are timely and relevant. The outputs of these models can vary in complexity and specificity, depending on the input and the intended use case. For instance, a rule-based model might output a limited set of predefined setting templates, such as “Tropical Island,” “Medieval Village,” or “Futuristic Metropolis.” In contrast, a generative model like GPT could produce rich, detailed descriptions of settings, including specific visual and sensory details, tailored to the input data. Multi-model approaches could combine these, with one model generating a general setting concept and another refining it with granular details or ensuring compatibility with specific constraints (e.g., hardware limitations). Outputs could also include interactive suggestions, where users provide iterative feedback to refine the settings further.

To enhance functionality, multiple models can work collaboratively, leveraging their unique strengths. For example, a natural language processing (NLP) model could interpret user-provided text input, such as “I want a setting with mountains and ancient ruins,” while a computer vision model generates visual representations of the described setting. Alternatively, a recommendation model could filter and rank outputs from a generative model based on user preferences or system-defined priorities. By combining models, the gaming system 212 can provide not only diverse and creative suggestions but also ensure those suggestions are aligned with user needs and technical constraints of the system.

According to some embodiments, a graphical user interface page is generated, including the one or more setting suggestion 218 results of the one or more models, and transmitted to a display communicatively coupled to the gaming system 212.

According to some embodiments, the setting suggestion 218 is used by the gaming system 212 to auto-configure the settings of the of the gaming environment (e.g., game console 204, gaming system 212). If the setting suggestion 218 is auto-configured, the user may receive a notification that one or more of their settings have been changed. According to some embodiments, the setting suggestion 218 can be a video file, audio file, and/or image file that is/are used to present content on a graphical user interface of a device (e.g., game console 204). If the setting suggestion 218 is presented to the user, the user may be directed to the particular settings, for easy access.

According to some embodiments, the gaming system 212 may include one or more systems (e.g., memories and processors). The system(s) of the gaming system 212 may execute code that processes console data (e.g., game data, image data, scene data, audio data, text data, vector data, conditions, etc.) of a gaming console that can be part of or separate from the gaming system 212. The system(s) may include one or more machine learning models (e.g., machine learning models with frozen parameter weights, a classification model, a diffusion model, a clustering machine learning model, etc.). The system(s) additionally/alternatively can access one or more machine learning models (e.g., run an instance of model stored on a server). Systems are referred to and described throughout the description herein. The systems are referred to for the simplicity of explanation. The systems may be implemented using hardware (e.g., a processor, memory, a graphics card, etc.). The systems may be implemented using a rule-based approach (e.g., using a ruleset (e.g., outlining specific conditions and actions to follow)), an algorithm, and/or a trained machine learning model. A system included in the system(s) may include a service and/or hardware local or remote to the other system(s). A rule-based approach may ensure consistent and logical outcomes based on established criteria. A machine learning model can enable the system to adapt and improve its performance over time. Implementing one or more of the system(s) with a machine learning model and/or a rule based approach can enable the system(s) to handle a wide variety of tasks, from dynamic decision making to structured, rule-driven processes, depending on the requirements of the gaming system. In certain embodiments, the game console can be implemented by a server.

A network can be configured to connect the game console and the gaming system 212. The network can be configured to connect any combination of the system components. In certain embodiments, the network is not part of the entertainment environment. For example, the gaming system 212 can run locally on the game console, and/or one or more of the system(s) may run locally on the game console. Each of the network data connections can be implemented over a public (e.g., the internet) or private (e.g., an intranet) network, whereby an access point, a router, and/or another network node can communicatively couple the game console and the gaming system. A data connection between the components can be a wired data connection (e.g., a universal serial bus (USB) connector), or a wireless connection (e.g., a radio-frequency-based connection). Data connections may also be made using a mesh network. A data connection may also provide a power connection. A power connection can supply power to the connected component. The data connection can provide for data moving to and from system components. One having ordinary skill in the art would recognize that devices may be communicatively coupled using a network (e.g., a local area network (LAN), wide area network (WAN), etc.). Further devices may be communicatively coupled through a combination of wired and wireless means (e.g., wireless connection to a router that is connected via an ethernet cable to a server).

### III. Example Setting Suggestions

According to some embodiments, the generated setting suggestions can be integrated into the gaming system's dashboard or home screen in visually appealing and interactive ways, enhancing user engagement and personalization. For example, the gaming system could present the suggestions as a carousel of thumbnails, each accompanied by a brief description of the outcome of implementing the setting suggestions, such as “Lush Forest Adventure” or “Cyberpunk Cityscape at Night.” Users could select individual settings to preview more details, including sample visuals, audio elements, or gameplay highlights. Additionally, the interface could offer options for users to accept one setting, accept all the suggested settings in bulk, or opt into an auto-configuration mode where the system automatically applies the most relevant or popular setting based on user preferences or behavior patterns. To further enhance the experience, users could have the ability to customize the suggestions by providing feedback, such as adjusting themes, colors, or difficulty levels, allowing for a blend of automation and user control.

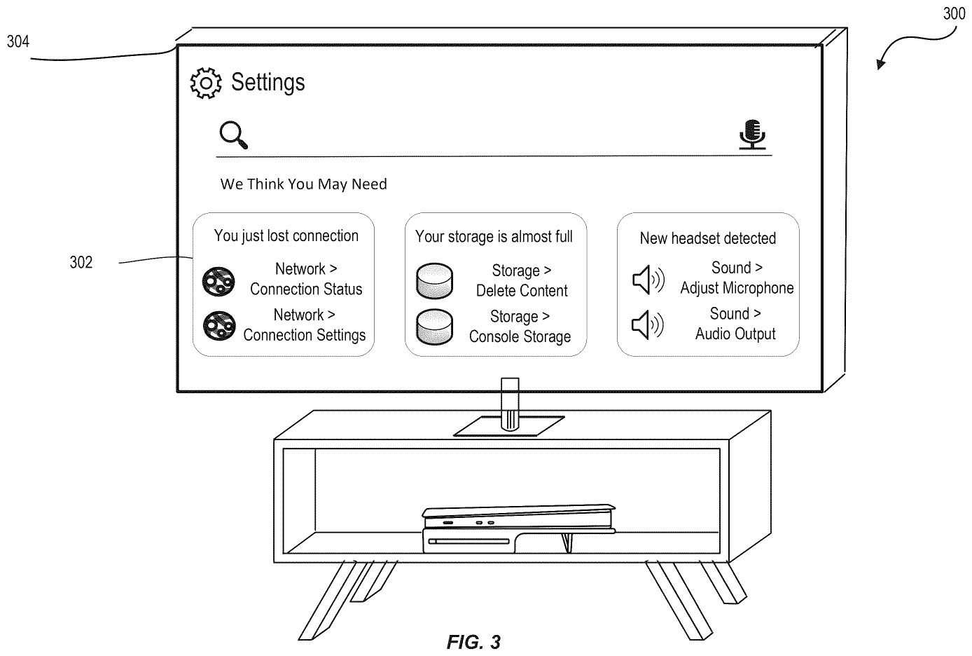

FIG. 3 illustrates an example presentation 300 of a setting suggestion, according to some embodiments of the present disclosure. As illustrated in FIG. 3, the setting suggestion 302 can be presented on a graphical user interface 304 of a device (such as the game console 204, as described above).

For example, when a user navigates to the settings page, they can be greeted with a “Smart Suggestions” panel. The panel can be designed to optimize the user's experience by offering proactive, real-time recommendations based on their recent activity, system conditions, and or popular settings used by similar users. The setting suggestions can be displayed as an intuitive, scrollable list of cards, each with icons and/or concise, action- oriented text. For instance, the first card might read: “You just lost connection,” and may guide the user to reconfigure their network setting to reconnect. In an example, clicking this card can expand a guided setup that checks Wi-Fi connectivity, lists available networks, and provides troubleshooting tips for improving signal strength. In an example, a second card might read: “Your storage is almost full” and may guide the user to free up space or manage their files. Selecting this option can bring up a detailed breakdown of storage usage, highlight large or unused files, and/or provide quick links to delete, move, or archive files. These suggestions not only diagnose potential issues but also provide actionable steps to resolve them directly from the display.

In an example, the Smart Suggestions panel could display: “New headset detected” and guide the user to configure audio settings for the best experience. This card can be tailored to the user's recent hardware change, offering one-click access to the audio settings menu. Once selected, the system can detect the headset's capabilities and recommend optimal configurations, such as enabling surround sound, adjusting microphone sensitivity, or setting the headset as the default audio device. Users can accept the suggested configuration with a single click or tweak the settings manually to match their preferences. Each card in the panel can include a “dismiss” button, allowing users to remove suggestions they don't find relevant. In an example, a toggle at the top of the panel can allow users to opt into an “Auto-Apply” feature, where the system automatically implements the most critical recommendations. The Smart Suggestions panel can be presented at other points of the user's interaction, with an interface of the display. The panel can be presented, for example, at a pause page of a paused game, when the user logs in to their account, and so on.

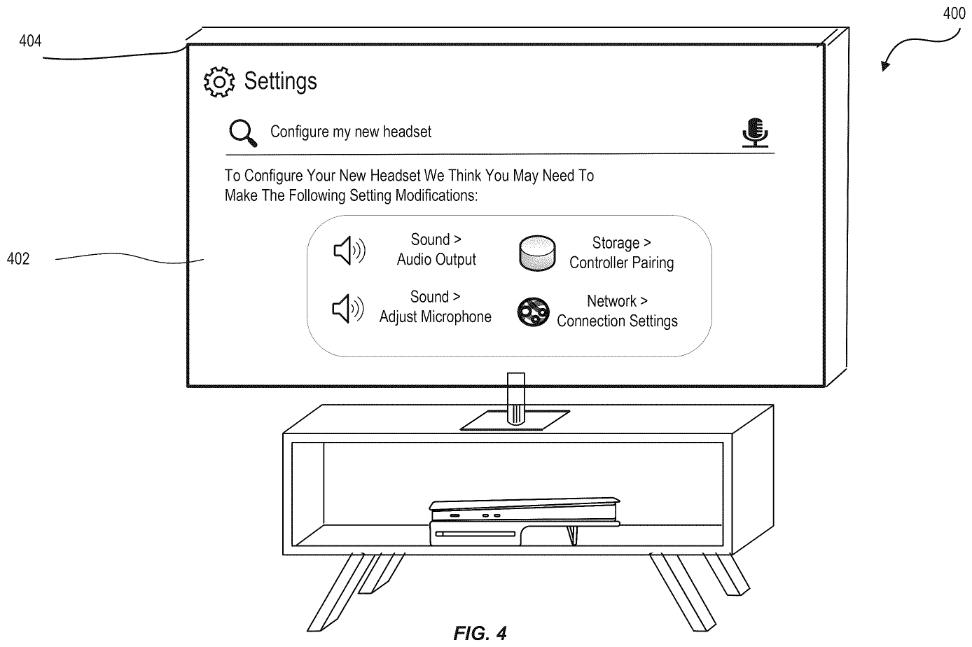

FIG. 4 illustrates an example presentation 400 of a setting suggestion, according to some embodiments of the present disclosure. As illustrated in FIG. 4, the setting suggestion 402 can be presented on a graphical user interface 404 of a device (such as the game console 204, as described above). For example, when a user navigates to the settings page and types a natural language request, such as “Configure my new headset,” for a desired gaming experience or desired action. In response, the user can be presented with a visually organized page that reads: “To configure your new headset, we think you may need to make the following setting modifications:”. This can be followed by a list of recommended adjustments, each displayed as an actionable link. For instance, the list might include setting suggestions, such as “Set your headset as your default audio device,” “Enable surround sound for immersive audio,” and “Adjust microphone sensitivity for clearer communication.” Each recommendation can also be interactive, where users can click directly on the links to access and modify the corresponding settings, without needing to navigate through multiple menus. At the bottom of the list, the gaming system might include a “Preview Sounds” button to test the new configuration or an “Apply All” option to implement all the suggestions simultaneously.

The interface can be designed to be intuitive. Each setting suggestion can include a brief explanation of its purpose, such as “Surround sound enhances direction audio cues for improved gameplay awareness.” Additionally, icons can be used to indicate whether a suggested modification is based on the capabilities of newly-detected hardware or the user's past preferences. For example, the gaming system can determine that the user often favors bass-booted audio and, therefore, might recommend enabling a bass-enhancement mode, if the headset supports it. The presentation can ensure that the user understands the purpose of the setting suggestions and how each contribute to the overall gaming experience.

As discussed above, according to some embodiments, the suggestion can be generated by the gaming system, using a combination of user-specific and hardware-specific data. For example, the gaming system can first detect the hardware, such as the headset, and identify its specifications, like surround sound support or microphone features. Simultaneously, the gaming system can reference the user's historical preferences, such as previously-configured audio settings, preferred sound profiles, or common gaming genres. For instance, if the user frequently plays competitive first-person shooters, the system might prioritize enabling surround sound for positional awareness. Additionally, the system could leverage crowd-sourced data or default presets for popular headsets, to suggest optimal configuration. By combining real-time hardware detection, user-specific preferences, and general best practices, the gaming system can provide personalized setting suggestions.

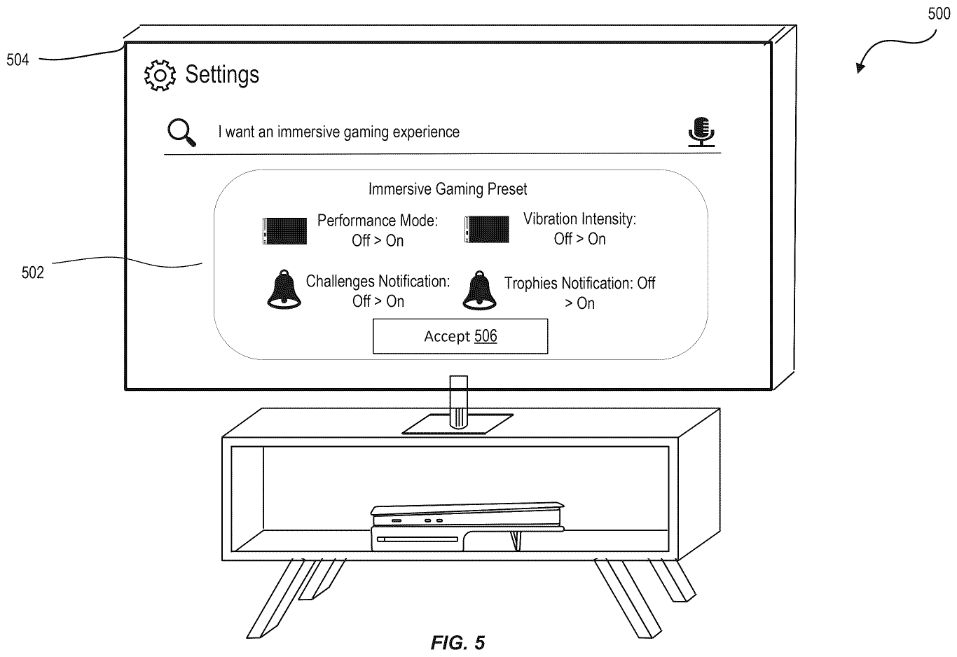

FIG. 5 illustrates an example presentation 500 of a setting suggestion, according to some embodiments of the present disclosure. As illustrated in FIG. 5, the setting suggestion 502 can be presented on a graphical user interface 504 of a device (such as the game console 204, as described above). For example, at a setting page, the user can type a natural language request, such as “I want an immersive gaming experience;” and the gaming system can then generate a curated response, tailored to both the user's preferences and general trends for immersive gaming experiences. The gaming system can respond with an “Immersive Gaming Preset,” including a group of settings to achieve the user's desired gaming experience. The setting suggestions can further be grouped into categories. For example, under “Graphics,” the gaming system might suggest enabling ultra-high resolution, ray tracing, and motion blur to enhance realism. In the “Audio” category, the gaming system could recommend activating surround sound, enabling spatial audio, and lowering background music volume to emphasize in-game effects. The “Gameplay” section might suggest activating features like dynamic weather effects or haptic feedback, if supported by the user's controller. Each setting can be presented alongside a brief explanation of how it contributes to immersion, such as “Ray tracing adds realistic lighting and reflections, bringing the game world to life.”

In some examples, the recommendations can be displayed as an interactive panel, with a preview button at the top, allowing the user to see a sample of how their game might look and sound with the suggested settings. Each category of settings can include toggles or sliders that users can adjust directly from the panel, with live previews applied in the background. For example, the user can instantly see the difference between standard and ray-traced lighting or hear the difference between stereo and surround sound. Additionally, the gaming system can offer an “Accept” button (Accept 506) to instantly implement all the recommended changes or an “Advanced Options” link for users who want to fine-tune settings further. For convenience, the system might also suggest saving this configuration as a custom profile labeled “Immersive Mode,” allowing users to switch back to it quickly in the future.

As discussed in greater detail above, the setting suggestions can be generated by the gaming system, using user-specific data and aggregated insights from general user preferences. The gaming system can analyze the user's gaming history to identify genres they frequently play, such as first-person shooters or open-world exploration games, and tailor the settings to align with what typically enhances immersion in those genres. For instance, if the user favors story-driven games, the gaming system might prioritize cinematic effects and ambient audio. Additionally, the gaming system can draw on crowd-sourced data to recommend settings that other users with similar preferences have rated highly for immersion. For example, if a particular combination of high-resolution graphics and dynamic shadows is popular among users seeking immersion, the gaming system can incorporate it into the preset.

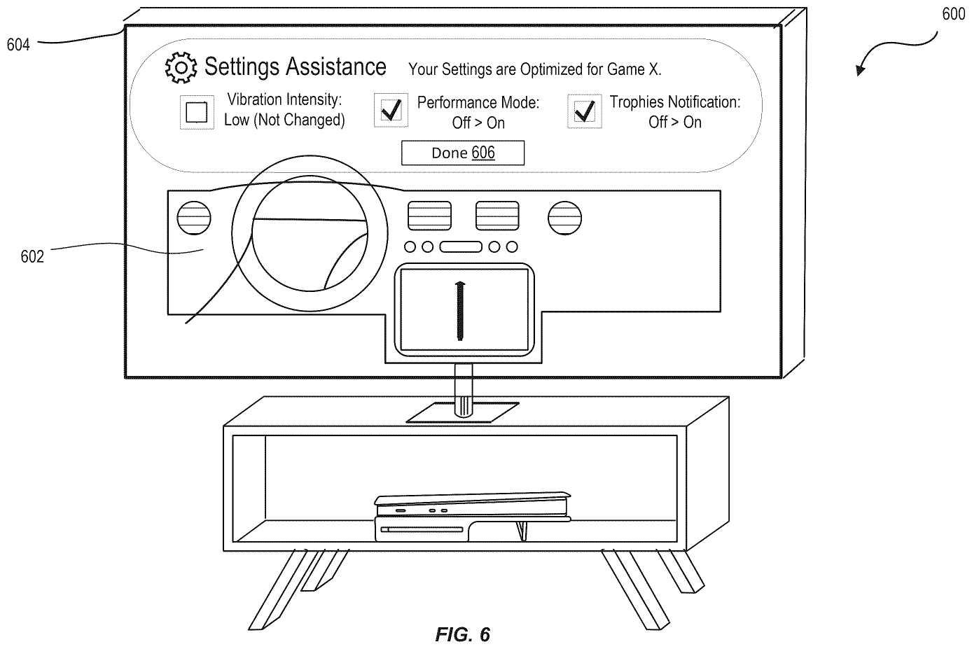

FIG. 6 illustrates an example presentation 600 of a setting suggestion, according to some embodiments of the present disclosure. As illustrated in FIG. 6, the setting suggestion 602 can be presented on a graphical user interface 604 of a device (such as the game console 204, as described above). For example, when a user clicks on a “Setting Assistance” button or triggers the panel by opening a new game, reaching a new level, or entering a particularly challenging stage, the system can present a dynamic “Recommended Settings” page. This page can be tailored to the specific game the user is playing, drawing on both user-specific data and aggregated insights from other users of the same game. The page might display a message like “We've noticed players often adjust their settings at this point to optimize their experience. Here's what we recommend for Game X based on your playstyle and preferences.” In some examples, the recommendation can be based on the user's skill level. For example, the gaming system can recommend enabling aim-assist or adjusting difficulty levels, if the user is struggling, based on their skill level and game progression.

Each recommendation can be presented with a toggle or checkbox, allowing the user to select individual settings or apply all suggestions at once with an “Apply All” or “Done” button (Done 606). The user can review and modify the suggestions before clicking the Done 606 button to save and seamlessly return to the game. The gaming system can also take into account the user's skill level: for a beginner, it might recommend simpler controls or reduced difficulty; while for an experienced player, it might suggest more challenging configurations, such as activating advanced physics or increasing enemy AI difficulty. By combining real-time game context, user-specific data, and community-driven insights, the gaming system provides setting suggestions that are not only relevant but also enhance the user's overall gaming experience.

In some embodiments, the setting suggestions can be presented on one or more devices associated with a user account (e.g., a mobile phone, a tablet, a computer, a television, another game console, etc.).

### IV. Example Process

One having ordinary skill in the art, with the benefit of the present disclosure, would recognize how other models described herein could be trained to perform all or part of the methods, operations, and/or processing described throughout. The techniques for training machine learning models described herein are not meant to be limiting, but as example implementations.

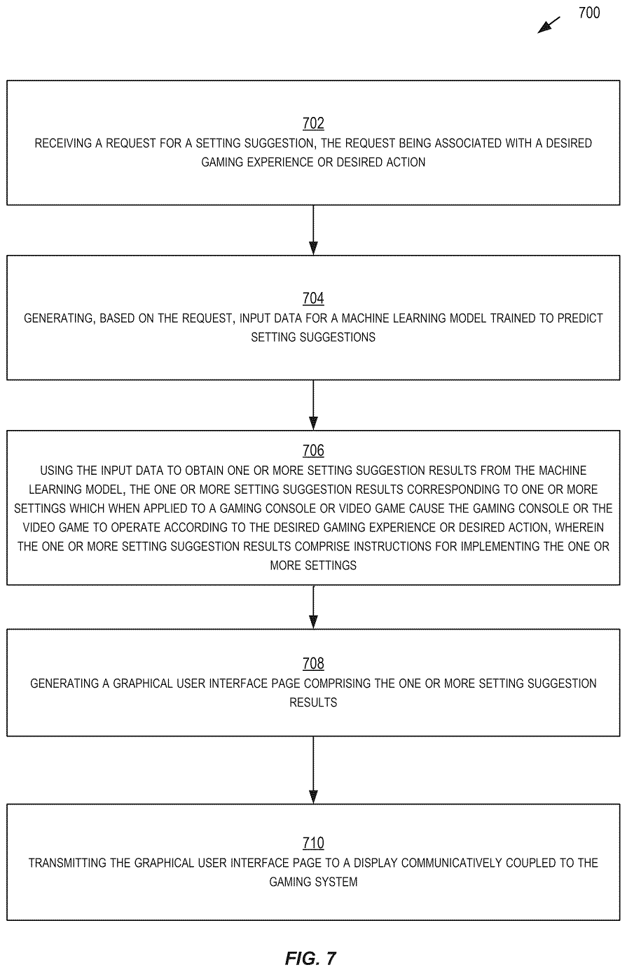

FIG. 7 illustrates an example process 700 for AI-driven video game suggestions, according to some embodiments of the present disclosure. The process may be performed to generate setting suggestions to a user of a gaming system.

The processing depicted in process 700, and any other FIGS. may be implemented in software (e.g., code, instructions, programs) executed by one or more processing units (e.g., processors, cores) of the respective systems, using hardware, or combinations thereof. The software may be stored on a non-transitory storage medium (e.g., on a memory device). The method presented in process 700, other FIGS., and described herein are intended to be illustrative and non-limiting. Although process 700 and other FIGS. depict the various processing steps occurring in a particular sequence or order, this is not intended to be limiting. In certain alternative embodiments, the processing may be performed in some different order, or some steps may also be performed in parallel. It should be appreciated that, in alternative embodiments, the processing depicted in process 700 and other FIGS. may include a greater number or a lesser number of steps than those depicted in the respective FIGS.

At block 702, one or more processors of a gaming system receive a request for a setting suggestion, the request being associated with a desired gaming experience or desired action. According to some embodiments, the gaming system can include a gaming console, a controller, and/or server(s). The desired gaming experience or desired action can be, for example, an immersive experience or rearranged controller buttons. According to some embodiments, the request is generated by the one or more processors receiving a natural language request input by the user. The natural language request can be input to a machine learning model (e.g., a second machine learning model) trained to determine the desired gaming experience or desired action based, at least in part, on the natural language request. Using the machine learning model, the one or more processors can generate the request for a setting suggestion. For example, a user might type or speak a sentence, such as “Optimize my settings for competitive play,” which can then be interpreted by the machine learning model to determine the appropriate configurations.

Additionally, the request can be triggered by context-based actions, such as restarting the console, launching a specific game, or opening a newly installed title, to proactively suggest relevant settings. The request can be narrowly tailored to a particular action desired to be achieved or broadly requesting a general gaming experience. For example, a user might request “Configure my headset,” prompting the system to adjust or suggest adjusting microphone sensitivity, sound balance, and chat audio levels for optimal performance. An example of a more general, experience-based request might be “Optimize my settings for playing with friends,” which could lead the gaming system to suggest configuring voice chat, multiplayer connectivity, and controller preferences, accordingly.

At block 704, based on the request, the one or more processors generate input data for a machine learning model trained to predict setting suggestions. In some examples, the machine learning model can be a generative AI model capable of receiving a prompt and using the input data to make predictions. When provided with input data, like user preferences, historical configurations, or gameplay context, the model can analyze patterns to recommend specific settings. In some examples, the model could be a predictive AI model that uses structured input data to make recommendations. By analyzing historical and contextual data patterns, the model can predict optimal configurations, specific to a user's behavior and situational needs.

According to some embodiments, the machine learning model is configured to return the one or more setting suggestion results based, at least in part, on historical data of a group of users for a particular gaming experience or action provided to the machine learning model. For example, the setting suggestion results of the machine learning model can be based on patterns and behaviors of a group of users. Additionally, the request does not need to be associated with a particular user. For example, a user can be using a game console as a guest using a “guest mode,” where the request is not associated with a particular user account and does not rely on any user-specific data. The machine learning model can still generate setting suggestion results, based on having been trained on the habits and behaviors of a group of users.

According to some embodiments, the machine learning model is configured to return the one or more setting suggestion results based, at least in part, on comparing user data of a user associated with the request to the historical data of a group of users for a particular gaming experience or action. For example, the setting suggestion results of the machine learning model can be based on patterns and behaviors of the individual user (e.g., data of a user associated with a user account or the user-specific game console data). Additionally, the setting suggestion results of the machine learning model can be based on considering both the historical behavior of a particular user as well as the historical behavior of a group of users.

The historical data of a group of users can be stored in a database of the gaming system and can include data that is aggregated across a wide range of users, to identify common trends and preferences for optimal setting recommendations. This could include data, such as the most frequently used settings for specific games, game genres, or even particular levels or missions within those games. For example, if most users in a first-person shooter lower motion blur and increase controller sensitivity for competitive matches, this trend can inform default recommendations for new users engaging in similar scenarios. Additionally, the historical data of a group of users can include information about the most commonly enabled accessibility features, such as subtitles or high-contrast visuals.

The user data of a user associated with the request can include data stored in the database, data stored in a gaming console, and/or a user account. The user data can include the user's gaming history, such as the types of games they play most frequently, the settings they have adjusted in the past, and their typical play session durations. For instance, if a user consistently increases the brightness and adjusts the audio balance to emphasize dialogue in story-driven games, the gaming system can suggest similar configurations, when they start a new game in the same genre.

At block 706, the one or more processors use the input data to obtain one or more setting suggestion results from the machine learning model, the one or more setting suggestion results corresponding to one or more settings, which, when applied to a gaming console or video game, cause the gaming console or the video game to operate according to the desired gaming experience or desired action, wherein the one or more setting suggestion results comprise instructions for implementing the one or more settings. The gaming console or video game can be part of the gaming system or can be part of another gaming system that can communicate with the gaming system.

The instructions for implementing the settings can include specific technical parameters, such as values for resolution, frame rates, audio levels, or device-specific configurations, and may be formatted in a way that allows direct execution by the system's software. For example, if the system suggests enabling surround sound, the instructions might include the exact steps or API calls required to modify the audio settings, activate spatial audio features, and adjust balance levels. Additionally, these instructions can be dynamically tailored to the user's hardware and software environment, ensuring compatibility and optimal performance. In cases where the setting suggestions are presented to the user, the instructions can be interactive, allowing the user to accept, reject, or modify individual recommendations through a user-friendly interface. By embedding actionable instructions within the setting suggestion results, the system minimizes the need for manual intervention, reduces the risk of configuration errors, and enhances the overall efficiency and user experience.

According to some embodiments, the machine learning model is trained to predict one or more setting suggestions, to achieve a particular gaming experience or action based on historical data of a group of users for a particular gaming experience or action; and the machine learning model is trained to predict the particular gaming experience or action of the historical data of the group of users based, at least in part, on determining patterns in the historical data of the group of users corresponding to associated gaming experiences or actions.

According to some embodiments, the machine learning model is trained to predict setting suggestions, to achieve the particular gaming experience or action based on historical data of a user associated with the request and the historical data the group of users; and the machine learning model is trained to predict the particular gaming experience or action based, at least in part, on determining patterns in the historical data of the user and the historical data of the group of users corresponding to the associated gaming experiences or actions.

For example, the system may utilize a database that categorizes historical user and aggregated data, mapping specific settings configurations (e.g., enabling ray tracing, surround sound, or reduced HUD elements) to gameplay telemetry data (e.g., movement speed, combat frequency, or time spent in dialogue scenes). The machine learning model can further refine these associations by analyzing patterns in user behavior, such as the settings commonly adjusted during certain types of gameplay or the preferences of users with similar playstyles. Additionally, real-time telemetry data and contextual triggers (e.g., entering a new game level, detecting a hardware change) can activate pre-mapped associations, ensuring the system delivers timely and contextually-relevant setting suggestions.

At block 708, the one or more processors generate a graphical user interface page comprising the one or more setting suggestion results. According to some embodiments, the one or more processors can configure the one or more setting suggestion results on the game console or video game. For example, the setting suggestion results can be used to auto-configure the settings of the of the gaming environment (e.g., game console, gaming system). If the setting suggestion results are auto-configured, the user may receive a notification that one or more of their settings have been changed.

At block 710, the one or more processors transmit the graphical user interface page to a display communicatively coupled to the gaming system. For example, the setting suggestion results can be a video file, audio file, and/or image file that is/are used to present content on a graphical user interface of a device (e.g., a game console). If the setting suggestion results are presented to the user, the user may be directed to the particular settings, for easy access. Additionally, the display can be an external display (e.g., a TV) coupled to the gaming system.

### V. Hardware Implementation

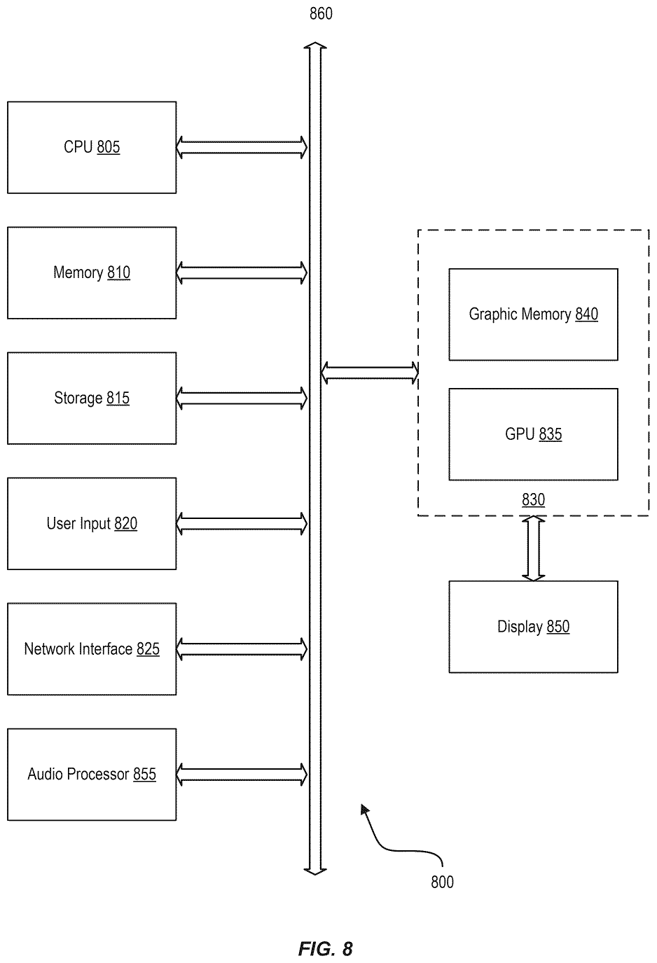

FIG. 8 illustrates an example of a hardware system suitable for implementing a computer system, according to embodiments of the present disclosure. The computer system 800 represents, for example, a video game system, a backend set of servers, or other types of a computer system. The computer system 800 includes a central processing unit (CPU) 805 for running software applications and optionally an operating system. The CPU 805 may be made up of one or more homogeneous or heterogeneous processing cores. Memory 810 stores applications and data for use by the CPU 805. Storage 815 provides non-volatile storage and other computer-readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 820 communicate user inputs from one or more users to the computer system 800, examples of which may include keyboards, mice, thumbsticks, touchpads, touchscreens, still or video cameras, and/or microphones. A network interface 825 allows the computer system 800 to communicate with other computer systems via an electronic communications network and may include wired or wireless communication over local area networks and wide area networks, such as the Internet. An audio processor 855 is adapted to generate analog or digital audio output from instructions and/or data provided by the CPU 805, memory 810, and/or storage 815. The components of computer system 800, including the CPU 805, memory 810, data storage 815, user input devices 820, network interface 825, and audio processor 855 are connected via one or more data buses 860.

A graphics subsystem 830 is further connected with the data bus 860 and the components of the computer system 800. The graphics subsystem 830 includes a graphics processing unit (GPU) 835 and graphics memory 840. The graphics memory 840 includes a display memory (e.g., a frame buffer) used for storing pixel data for each pixel of an output image. The graphics memory 840 can be integrated in the same device as the GPU 835, connected as a separate device with the GPU 835, and/or implemented within the memory 810. Pixel data can be provided to the graphics memory 840 directly from the CPU 805. Alternatively, the CPU 805 provides the GPU 835 with data and/or instructions defining the desired output images, from which the GPU 835 generates the pixel data of one or more output images. The data and/or instructions defining the desired output images can be stored in the memory 810 and/or graphics memory 840. In an embodiment, the GPU 835 includes 3D rendering capabilities, for generating pixel data for output images from instructions and data defining the geometry, lighting, shading, texturing, motion, and/or camera parameters for a scene. The GPU 835 can further include one or more programmable execution units capable of executing shader programs.

The graphics subsystem 830 periodically outputs pixel data for an image from the graphics memory 840 to be displayed on the display device 850. The display device 850 can be any device capable of displaying visual information, in response to a signal from the computer system 800, including CRT, LCD, plasma, and OLED displays. The computer system 800 can provide the display device 850 with an analog or digital signal.

In accordance with various embodiments, the CPU 805 is one or more general-purpose microprocessors, having one or more processing cores. Further embodiments can be implemented using one or more CPUs 805, with microprocessor architectures specifically adapted for highly-parallel and computationally-intensive applications, such as media and interactive entertainment applications.

The components of a system may be connected via a network, which may be any combination of the following: the Internet, an IP network, an intranet, a wide-area network (WAN), a local-area network (LAN), a virtual private network (VPN), the Public Switched Telephone Network (PSTN), or any other type of network supporting data communication between devices described herein, or in different embodiments. A network may include both wired and wireless connections, including optical links. Many other examples are possible and apparent to those skilled in the art, in light of this disclosure. In the discussion herein, a network may or may not be noted specifically.

As used herein, when an action is “based on” something, this means the action is based, at least in part, on at least a part of the something. As used herein, the terms “substantially,” “approximately” and “about” are defined as being largely, but not necessarily wholly, what is specified (and include wholly what is specified), as understood by one of ordinary skill in the art. In any disclosed embodiment, the term “substantially,” “approximately,” or “about” may be substituted with “within [a percentage] of” what is specified, where the percentage includes 0.1, 1, 7, and 8 percent.

Disjunctive language such as the phrase “at least one of X, Y, or Z,” unless specifically stated otherwise, is intended to be understood within the context, as used in general, to present that an item, term, etc., may be either X, Y, Z, or any combination thereof (e.g., X, Y, and/or Z). Thus, such disjunctive language is not generally intended to, and should not, imply that certain embodiments require at least one of X, at least one of Y, and at least one of Z to each be present.

Preferred embodiments of this disclosure are described herein, including the best mode known for carrying out the disclosure. Variations of those preferred embodiments may become apparent to those of ordinary skill in the art, upon reading the foregoing description. Those of ordinary skill should be able to employ such variations as appropriate, and the disclosure may be practiced otherwise than as specifically described herein. Accordingly, this disclosure includes all modifications and equivalents of the subject matter recited in the claims appended hereto, as permitted by applicable law. Moreover, any combination of the above-described elements, in all possible variations thereof, is encompassed by the disclosure, unless otherwise indicated herein.

All references, including publications, patent applications, and patents, cited herein, are hereby incorporated by reference, to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, the embodiments can be utilized in any number of environments and applications, beyond those described herein, without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components, as appropriate. For instance, it should be appreciated that, in alternative embodiments, the methods may be performed in an order different from that described and that various steps may be added, omitted, or combined. Also, features described, with respect to certain embodiments, may be combined in various other embodiments. Different aspects and elements of the embodiments may be combined in a similar manner. Also, it should be emphasized that technology evolves and, thus, many of the elements are examples and should not be interpreted to limit the scope of the disclosure.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail, in order to avoid obscuring the embodiments.

Also, it is noted that the embodiments may be described as a process, which is depicted as a flow diagram or block diagram. Although each may describe the operations as a sequential process, many of the operations can be performed in parallel or concurrently. In addition, the order of the operations may be rearranged. A process may have additional steps, not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium, such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 46%, 90%, 100%, 105%, 109%, 109.9%, 135% or, depending on the context within which the term substantially appears, values otherwise known in the art.

Additionally, spatially-relative terms, such as “bottom,” “top,” and the like, can be used to describe an element and/or feature's relationship to other element(s) and/or feature(s), as, for example, illustrated in the FIGS. It will be understood that the spatially-relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially-relative descriptors used herein interpreted, accordingly.

Having described several embodiments, it will be recognized by those of skill in the art that various modifications, alternative constructions, and equivalents may be used without departing from the spirit of the disclosure. For example, the above elements may merely be a component of a larger system, wherein other rules may take precedence over, or otherwise modify, the application of the disclosure. Also, a number of steps may be undertaken before, during, or after the above elements are considered. Accordingly, the above description should not be taken as limiting the scope of the disclosure.

What is claimed is:

1. A method comprising:
receiving, by one or more processors of a gaming system, a request for a setting suggestion, the request being associated with a desired gaming experience or desired action;
generating, by the one or more processors and based on the request, input data for a machine learning model trained to predict setting suggestions;
using, by the one or more processors, the input data to obtain one or more setting suggestion results from the machine learning model, the one or more setting suggestion results corresponding to one or more settings which when applied to a gaming console or video game cause the gaming console or the video game to operate according to the desired gaming experience or desired action, wherein the one or more setting suggestion results comprise instructions for implementing the one or more settings;
generating, by the one or more processors, a graphical user interface page comprising the one or more setting suggestion results; and
transmitting, by the one or more processors, the graphical user interface page to a display communicatively coupled to the gaming system.

2. The method of claim 1, wherein the machine learning model is configured to return the one or more setting suggestion results based at least in part on historical data of a group of users for a particular gaming experience or action provided to the machine learning model.

3. The method of claim 2, wherein the machine learning model is configured to return the one or more setting suggestion results based at least in part on comparing user data of a user associated with the request to the historical data of a group of users for a particular gaming experience or action.

4. The method of claim 1, further comprising:
configuring, by the one or more processors, the one or more setting suggestion results on the game console or video game.

5. The method of claim 1, further comprising:
receiving, by the one or more processors, a natural language request input by the user;
inputting, by the one or more processors, the natural language request to a second machine learning model trained to determine the desired gaming experience or desired action based at least in part on the natural language request; and
generating, by the one or more processors using the second machine learning model, the request for a setting suggestion.

6. The method of claim 1, wherein the machine learning model is trained to predict one or more setting suggestions to achieve a particular gaming experience or action based on historical data of a group of users for a particular gaming experience or action, and wherein the machine learning model is trained to predict the particular gaming experience or action of the historical data of the group of users based at least in part on determining patterns in the historical data of the group of users corresponding to associated gaming experiences or actions.

7. The method of claim 6, wherein the machine learning model is trained to predict the setting suggestions to achieve the particular gaming experience or action based on historical data of a user associated with the request and the historical data the group of users, and wherein the machine learning model is trained to predict the particular gaming experience or action based at least in part on determining patterns in the historical data of the user and the historical data of the group of users corresponding to the associated gaming experiences or actions.

8. A gaming system comprising:
one or more processors; and
one or more storage media storing instructions that, when executed by the one or more processors, cause the gaming system to perform operations comprising:
receiving a request for a setting suggestion, the request being associated with a desired gaming experience or desired action;
generating, based on the request, input data for a machine learning model trained to predict setting suggestions;
using the input data to obtain one or more setting suggestion results from the machine learning model, the one or more setting suggestion results corresponding to one or more settings which when applied to a gaming console or video game cause the gaming console or the video game to operate according to the desired gaming experience or desired action, wherein the one or more setting suggestion results comprise instructions for implementing the one or more settings;
generating a graphical user interface page comprising the one or more setting suggestion results; and
transmitting the graphical user interface page to a display communicatively coupled to the gaming system.

9. The gaming system of claim 8, wherein the machine learning model is configured to return the one or more setting suggestion results based at least in part on historical data of a group of users for a particular gaming experience or action.

10. The gaming system of claim 9, wherein the machine learning model is configured to return the one or more setting suggestion results based at least in part on comparing user data of a user associated with the request to the historical data of a group of users for a particular gaming experience or action.

11. The gaming system of claim 8, the operations further comprising:
configuring the one or more setting suggestion results on the game console or video game.

12. The gaming system of claim 8, the operations further comprising:
receiving a natural language request input by the user;
inputting the natural language request to a second machine learning model trained to determine the desired gaming experience or desired action based at least in part on the natural language request; and
generating, using the second machine learning model, the request for a setting suggestion.

13. The gaming system of claim 8, wherein the machine learning model is trained to predict one or more setting suggestions to achieve a particular gaming experience or action based on historical data of a group of users for a particular gaming experience or action, and wherein the machine learning model is trained to predict the particular gaming experience or action of the historical data of the group of users based at least in part on determining patterns in the historical data of the group of users corresponding to associated gaming experiences or actions.

14. The gaming system of claim 13, wherein the machine learning model is trained to predict the setting suggestions to achieve the particular gaming experience or action based on historical data of a user associated with the request and the historical data the group of users, and wherein the machine learning model is trained to predict the particular gaming experience or action based at least in part on determining patterns in the historical data of the user and the historical data of the group of users corresponding to the associated gaming experiences or actions.

15. One or more non-transitory computer-readable storage media storing instructions that, upon execution by one or more processors of a gaming system, cause the gaming system to perform operations comprising:
receiving a request for a setting suggestion, the request being associated with a desired gaming experience or desired action;
generating, based on the request, input data for a machine learning model trained to predict setting suggestions;
using the input data to obtain one or more setting suggestion results from the machine learning model, the one or more setting suggestion results corresponding to one or more settings which when applied to a gaming console or video game cause the gaming console or the video game to operate according to the desired gaming experience or desired action, wherein the one or more setting suggestion results comprise instructions for implementing the one or more settings;
generating a graphical user interface page comprising the one or more setting suggestion results; and
transmitting the graphical user interface page to a display communicatively coupled to the gaming system.

16. The one or more non-transitory computer-readable storage media of claim 15, wherein the machine learning model is configured to return the one or more setting suggestion results based at least in part on historical data of a group of users for a particular gaming experience or action.

17. The one or more non-transitory computer-readable storage media of claim 16, wherein the machine learning model is configured to return the one or more setting suggestion results based at least in part on comparing user data of a user associated with the request to the historical data of a group of users for a particular gaming experience or action.

18. The one or more non-transitory computer-readable storage media of claim 15, the operations further comprising:
receiving a natural language request input by the user;
inputting the natural language request to a second machine learning model trained to determine the desired gaming experience or desired action based at least in part on the natural language request; and
generating, using the second machine learning model, the request for a setting suggestion.

19. The one or more non-transitory computer-readable storage media of claim 15, wherein the machine learning model is trained to predict one or more setting suggestions to achieve a particular gaming experience or action based on historical data of a group of users for a particular gaming experience or action, and wherein the machine learning model is trained to predict the particular gaming experience or action of the historical data of the group of users based at least in part on determining patterns in the historical data of the group of users corresponding to associated gaming experiences or actions.

20. The one or more non-transitory computer-readable storage media of claim 19, wherein the machine learning model is trained to predict to setting suggestions to achieve the particular gaming experience or action based on historical data of a user associated with the request and the historical data the group of users, and wherein the machine learning model is trained to predict the particular gaming experience or action based at least in part on determining patterns in the historical data of the user and the historical data of the group of users corresponding to the associated gaming experiences or actions.
